(19) United States
(12) Patent Application Publication
(10) Pub. No.: US 2015/0197904 A1
(43) Pub. Date: Jul. 16, 2015

(54) VEHICLE MOUNTED ICE MELTING DEVICE

(71) Applicant: Thomas Collins, Charlotte, NC (US)

(72) Inventor: Thomas Collins, Charlotte, NC (US)

(21) Appl. No.: 14/153,023

(22) Filed: Jan. 11, 2014

(51) Int. Cl. E01H 5/10; H05B 11/00

(52) U.S. Cl. CPC E01H 5/106; H05B 11/00

(57) ABSTRACT

A vehicle mounted ice melting device for melting ice and snow the ground surface in front of a vehicle. The vehicle mounted ice melting device, which is adapted to mount on a vehicle's front bumper, comprises a base frame having an upper structure and a lower structure. The upper structure is a hollow passageway which includes a plurality of heating coils, and constructed to take oncoming air and redirect it through it's the body of the upper structure, past the heating coils to rapidly heat it, and then down to the ground immediately in front of the vehicle so the heated air contacts the ground surface. The lower portion is defined by a infrared laser which projects radiation in the same direction as the heated air which is redirected by the upper structure.

### BACKGROUND OF THE INVENTION

1. Field of the Invention

This invention relates generally to automobile accessories and, more particularly, to a vehicle mounted heat projecting device for melting ice on a road in front of a vehicle.

2. Description of the Prior Art

In many geographic areas, it common for temperatures to drop below the freezing point of water, and even remain at such temperatures for a period of time, during certain seasons. When precipitation falls during such conditions, it can cause roads to be blanketed with ice, snow, or some combination of both. When roads are covered by ice and/or snow, it is well known that their surface becomes slippery and motorists are less able to get and maintain traction while operating automobiles thereon. Indeed, the hazardous nature of roads slickened by ice and/or snow is well known and many solutions have been developed to mitigate these hazards by removing or melting ice and/or snow altogether or enhancing the traction one can get while on them.

A problem which still exists, however, is that most solutions for removing or melting ice and/or snow on road surfaces, such as the deployment of snowplows and salt trucks, require centralized operation and significant pooled resources to employ. Because of this, such solutions are not always available to users when needed. On the other hand, solutions which can be employed by an individual user as needed, such as chained tires, typically rely on attempting to enhance traction. Such attempts, however, are often unreliable at best to provide sufficient traction on what is an inherently unstable surface and can be damaging to the road surface. Thus, there remains a need for a vehicle mounted ice melting device which would allow ice and/or snow on the ground surface in front of a vehicle to be melted. It would be helpful if such a vehicle mounted ice melting device projected heat in front of a vehicle so as to enable the melting of ice in the path of a moving vehicle. It would be additionally desirable for such a vehicle mounted ice melting device to operate off electrical power generated by the vehicle on which it was mounted.

The Applicant's invention described herein provides for an ice melting device adapted to project heat from the front of a vehicle to the surface of a road to melt ice and/or snow on the road. The primary components of Applicant's vehicle mounted ice melting device are a frame having an infrared laser and a plurality of heating coils. When in operation, the vehicle mounted ice melting device allows a user to safely travel on roads not treated by snow plows or salt trucks without the use of chained tires. As a result, many of the limitations imposed by road ice melting solutions of the prior art are removed.

### SUMMARY OF THE INVENTION

A vehicle mounted ice melting device for projecting heat on the ground immediately in front of a vehicle to melt ice and snow on that portion of ground surface before the vehicle passes over it. The vehicle mounted ice melting device, which is adapted to mount on a vehicle's front bumper, comprises a base frame having an upper structure and a lower structure. The base frame provides a housing means for mounting on a vehicle. The upper structure is a hollow passageway which includes a plurality of heating coils, and constructed to take oncoming air and redirect it through it's the body of the upper structure, past the heating coils to rapidly heat it, and then down to the ground immediately in front of the vehicle so the heated air contacts the ground surface. In this regard, the upper structure provides a means for directing heated air. The lower portion is defined by a infrared laser which projects infrared radiation in the same direction as the heated air which is redirected by the upper structure. The lower portion is thus able to provide a means for projecting radiation. By this dual heat projecting mechanism, the ground in front of a vehicle can be warmed sufficiently to melt the ice and/or on the surface of the ground.

The vehicle mounted ice melting device is constructed to direct the heated air and radiation on the ground surface up to five feet in front of the vehicle on which it is mounted. Thus, the vehicle mounted ice melting device while in continuous operations can continuously melt ice and/or snow on the ground surface in front of a moving vehicle.

It is an object of this invention to provide a vehicle mounted ice melting device which would allow ice and/or snow on the ground surface in front of a vehicle to be melted.

It is another object of this invention to provide a vehicle mounted ice melting device which projects heat in front of a vehicle so as to enable the melting of ice in the path of a moving vehicle.

It is yet another object of this invention to provide a vehicle mounted ice melting device to operate off electrical power generated by the vehicle on which it was mounted.

These and other objects will be apparent to one of skill in the art.

### BRIEF DESCRIPTION OF THE DRAWINGS

FIG. 1 is a front elevational view of a vehicle mounted ice melting device built in accordance with the present invention installed on the front bumper of an automobile.

FIG. 2 is a side elevational view of a vehicle mounted ice melting device built in accordance with the present invention installed on a bumper of an automobile in phantom.

### DETAILED DESCRIPTION OF THE INVENTION

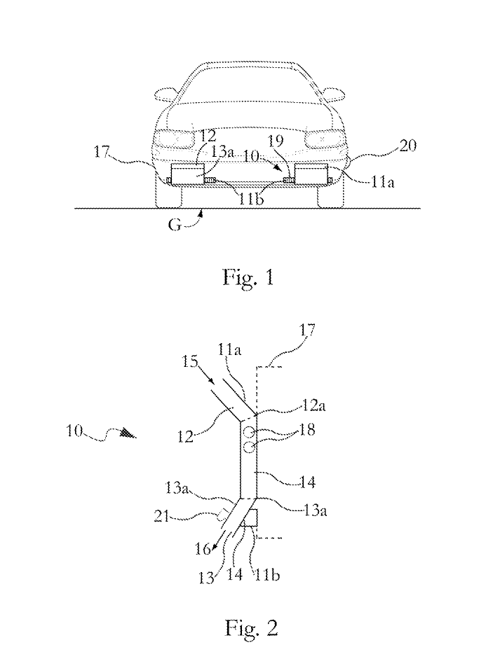

Referring now to the drawings and in particular FIGS. 1 and 2, a vehicle mounted ice melting device 10 is shown having a base frame 11 defined by an upper structure 11a and a lower structure 11b. The upper structure 11a includes an upper mouth 12 and a lower mouth 13 which are connected by a substantially hollow inner chamber 14. The opening of the upper mouth 12 is shaped to allow air flowing toward the base frame 11 in a entry direction 15 to enter the base frame 11, while the inner chamber 14 is constructed to allow air entering the upper mouth 12 to pass through and be directed towards the lower mouth 13. The lower mouth 13 is shaped to cause air passing through the inner chamber 14 and being directed thereto to be directed in an exit direction 16. It is contemplated that when the vehicle mounted ice melting device 10 is installed on the front bumper 17 of a vehicle, air directed in the exit direction 16 will flow towards a ground surface G in front of the vehicle on which the vehicle mounted ice melting device 10 is mounted. It is contemplated that as a vehicle having the vehicle mounted ice melting device 10 attached thereon moves forward on a road, relative air flow in a entry direction 15 will be automatically created, forcing air into the upper mouth 12 by virtue of such forward movement, consequently causes air flow in a exit direction 16 due to the nature of the shape and construction of the base frame 11. The lower mouth 13 is further shaped with a front lip 13a which extends down towards the ground surface G far enough to substantially prevent air from entering the lower mouth 13. By virtue of this front lip 13a, the base frame 11 can maintain air flow in one direction; from the entry direction 15 to the exit direction 16.

Inside the hollow inner chamber 14 are two electric heating coils 18 and a first set of attachment braces 12a and a second set of attachment braces 13a. The heating coils 18 are disposed in the inner chamber so that air passing through the inner chamber is rapidly heated. In this manner, air which enters the upper mouth 12 is heated before it exits the lower mouth 13 and directed towards the ground surface G. The heated air provides one component of the heating mechanism of the vehicle mounted ice melting device 10.

The attachment braces 12a, 13a are each defined by a plurality of discrete bars which hold together the base frame 11. In operation, as air is forced through the inner chamber 14, it would exert pressure on the base frame 11 in a way which would push it apart. The attachment braces 12a, 13a provide structure which resists this pressure and holds the base frame 11 together, while not impeding the flow of air through the inner chamber 14.

The other component of the heating mechanism of the vehicle mounted ice melting device 10 is an infrared radiation generator, defined in the preferred embodiment as a infrared laser 19. The infrared laser 19 directs infrared radiation in the exit direction 16 towards a ground surface G in front of the vehicle on which the vehicle mounted ice melting device 10 is mounted. The infrared radiation, along with the heated air, rapidly warms the ground surface G in front of the vehicle on which the vehicle mounted ice melting device 10 is mounted, allowing ice and/or snow on the ground surface G to be melted while the vehicle is in motion.

The heating coils 18 and the infrared laser 19 are both operated through an electrical connection to the alternator of the vehicle on which the vehicle mounted ice melting device 10 is mounted. In a conventional set up, a wire 20 which is electrically connected to the heating coils 18 and the infrared laser 19 is run to and connected with the alternator.

In the preferred embodiment, the vehicle mounted ice melting device 10 is attached to the bumper of a car through a plurality of screws (not shown).

In one embodiment of the vehicle mounted ice melting device 10, an infrared sensor 21 is included on the base frame 11 and configured to allow the vehicle mounted ice melting device 10 to detect icy conditions. In such an embodiment, the vehicle mounted ice melting device 10 includes an automatic internal switch to allow it to turn on automatically when icy roads are detected.

The instant invention has been shown and described herein in what is considered to be the most practical and preferred embodiment. It is recognized, however, that departures may be made therefrom within the scope of the invention and that obvious modifications will occur to a person skilled in the art.

1. A vehicle mounted ice melting device comprising:
a housing means for mounting on a vehicle;
a means for directing heated air integrated with said housing means;
a means for projecting radiation integrated with said housing means;
said means for directing heated air and said means for projecting radiation are configured to be powered with electrical power obtained from the alternator of the motor vehicle on which said base frame is attached; and
said housing means operative to simultaneously direct heated air and project radiation through said means for directing heated air and said means for projecting radiation, respectively.

2. The vehicle mounted ice melting device of claim 1, wherein said housing means is adapted to attach to the front bumper of a motor vehicle.

3-4. (canceled)

5. The vehicle mounted ice melting device of claim 1, wherein said means for projecting radiation projects infrared radiation.

6. A vehicle mounted ice melting device comprising:
a base frame adapted to attach to a motor vehicle;
an upper structure integrated with said base frame and defined by an upper mouth connected to a lower mouth by way of a substantially hollow chamber having at least one heating coil therein, wherein said upper structure is constructed to allow air to enter the upper mouth and force air entering the upper mouth to travel through the chamber, pass the at least one heating coil and exit the lower mouth;
a lower structure integrated with said base frame and defined by a radiation generator, wherein said radiation generator is operative to project radiation in the same direction as the air exiting the lower mouth of the upper structure; and
said base frame operative to simultaneously direct heated air and project radiation through said upper structure and said lower structure, respectively.

7. The vehicle mounted ice melting device of claim 6, wherein said base frame is adapted to attach to the front bumper of a motor vehicle.

8. The vehicle mounted ice melting device of claim 6, wherein said upper structure and said lower structure are configured to be powered with electrical power obtained from the motor vehicle on which said base frame is attached.

9. The vehicle mounted ice melting device of claim 8, wherein said upper structure and said lower structure are configured to be powered with electrical power obtained from the alternator of the motor vehicle on which said base frame is attached.

10. The vehicle mounted ice melting device of claim 6, wherein said radiation generator is an infrared laser.

11. The vehicle mounted ice melting device of claim 6, wherein said upper structure is disposed on said base frame above said lower structure.

12. The vehicle mounted ice melting device of claim 6, additionally comprising a infrared sensor integrated with said base frame, wherein said infrared sense is configured to sense the presence of icy roads and generate signals which cause the at least one heating coil and radiation generator to turn on or off.
